(19) United States
(12) Patent Application Publication
(10) Pub. No.: US 2025/0191607 A1
(43) Pub. Date: Jun. 12, 2025

(54) INFORMATION PROCESSING APPARATUS, INFORMATION PROCESSING METHOD, INFORMATION PROCESSING PROGRAM, AND INFORMATION PROCESSING SYSTEM

(71) Applicant: SONY GROUP CORPORATION, TOKYO (JP)

(72) Inventor: YUSUKE MISAWA, TOKYO (JP)

(21) Appl. No.: 18/842,325

(22) PCT Filed: Jan. 13, 2023
(86) PCT No.: PCT/JP2023/000764

§ 371 Date: Aug. 28, 2024

(30) Foreign Application Priority Data
Mar. 7, 2022 (JP) 2022-034660

(51) Int. Cl. G10L 25/78; G10L 15/02; G10L 21/0272

(52) U.S. Cl. CPC G10L 25/78; G10L 15/02; G10L 21/0272

(57) ABSTRACT

To extract an utterance speech uttered by a specific user. An information processing apparatus includes a first speech extraction processing section that generates a first speech extraction signal by extracting an utterance speech component from a speech signal including an utterance speech uttered by a user, a correction signal generation section that generates a correction signal from a vibration signal indicating vibration of a part of the user that vibrates in conjunction with a user's utterance, and a post-processing section that generates an utterance speech signal indicating the utterance speech by post-processing the first speech extraction signal based on the correction signal.

### TECHNICAL FIELD

The present disclosure relates to an information processing apparatus, an information processing method, an information processing program, and an information processing system that extract an utterance speech uttered by a user.

### BACKGROUND ART

There is a known technology for extracting an utterance speech uttered by a user toward a microphone.

### CITATION LIST

### Patent Literature

Patent Literature 1: Japanese Patent Application Laid-open No. 2014-174255

### DISCLOSURE OF INVENTION

### Technical Problem

A machine-learning type speech extraction technology aims to extract only a human speech from a signal including a noise by learning a wide variety of speech samples without using a reference signal. On the other hand, when a microphone input signal includes speeches from multiple people, it is difficult to extract only a speech signal of a specific speaker from among them.

As an online meeting and the like are currently becoming popular, it is required to extract the utterance speech uttered by a specific user toward a microphone with high accuracy.

In view of the above circumstances, an object of the present disclosure is to extract the utterance speech uttered by the specific user.

### Solution to Problem

An information processing apparatus according to an embodiment of the present disclosure includes:
a first speech extraction processing section that generates a first speech extraction signal by extracting an utterance speech component from a speech signal including an utterance speech uttered by a user;
a correction signal generation section that generates a correction signal from a vibration signal indicating vibration of a part of the user that vibrates in conjunction with a user's utterance; and
a post-processing section that generates an utterance speech signal indicating the utterance speech by post-processing the first speech extraction signal based on the correction signal.

According to the present embodiment, since the first speech extraction signal is post-processed based on the correction signal, accuracy of the utterance speech signal is improved compared to the case in which the first speech extraction signal is assumed to be a final output.

The correction signal generation section may include a second speech extraction processing section that generates a second speech extraction signal by extracting the utterance speech component from the vibration signal, and
the post-processing section may generate the utterance speech signal by post-processing the first speech extraction signal based on the second speech extraction signal.

The vibration signal, which is the basis of the second speech extraction signal, does not merely indicate presence or absence of vibration (i.e., presence or absence of utterance) and depends on the utterance speech uttered by a target user, which enables generation of the highly accurate utterance speech signal.

The correction signal generation section may include an utterance detection section that generates a masking signal indicating presence or absence and intensity of the utterance speech from the vibration signal, and
the post-processing section may generate the utterance speech signal by post-processing the first speech extraction signal based on the masking signal.

The vibration signal, which is the basis of the masking signal, does not merely indicate presence or absence of vibration (presence or absence of utterance) and depends on the utterance speech uttered by the target user, which enables generation of the highly accurate utterance speech signal.

The correction signal generation section may include a second speech extraction processing section that generates a second speech extraction signal by extracting the utterance speech component from the vibration signal, and
an utterance detection section that generates a masking signal indicating presence or absence and intensity of the utterance speech from the vibration signal, in which the post-processing section may generate the utterance speech signal by post-processing the first speech extraction signal based on the second speech extraction signal and the masking signal.

According to the present embodiment, since the first speech extraction signal is post-processed based on the second speech extraction signal and the masking signal, the accuracy of the utterance speech signal is improved compared to the case in which the first speech extraction signal is post-processed based on either of them.

The first speech extraction processing section may generate the first speech extraction signal by inputting the speech signal to a first learning model learned to output a first speech extraction signal using the speech signal as training data.

The second speech extraction processing section may generate the second speech extraction signal by inputting the vibration signal to a second learning model learned to output a second speech extraction signal using the speech signal and the vibration signal as the training data.

The vibration signal, which is the basis of the second speech extraction signal, does not merely indicate presence or absence of vibration (presence or absence of utterance) and depends on the utterance speech uttered by the target user, which enables generation of the highly accurate utterance speech signal.

The utterance detection section may generate envelope information as the masking signal.

The envelope information indicates the presence or absence and intensity of the utterance speech. The envelope information does not merely indicate presence or absence of vibration (presence or absence of utterance) and depends on the utterance speech uttered by the target user, which enables generation of the highly accurate masking signal.

A part of the user that vibrates in conjunction with the user's utterance may be a part of a human body located in or around a larynx, an artificial organ, or a medical device.

The part of the user that vibrates in conjunction with the user's utterance is, for example, an organ, artificial vocal cords, typically vocal cords.

The post-processing section may output the utterance speech signal, or may output a removal signal generated by removing the utterance speech signal from the speech signal.

The utterance speech signal desirably matches an utterance speech waveform indicating only the utterance speech uttered by the target user. Only the utterance speech uttered by the target user may be output. Conversely, a background sound may be output.

The vibration signal may be generated by a vibration signal processing section that processes vibration input to a vibration input device to which the vibration of the part is input and generates the vibration signal.

The vibration signal processing section may be separate from the information processing apparatus or may be included in the information processing apparatus.

The vibration input device may be a sensor that directly detects the vibration of the part, may be built into a device worn on the human body, or may detect the vibration of the part by irradiating the part with a laser.

The device worn on the human body may be, for example, a neckband type device (neckband type headset, neckband type utterance assist device, etc.), apparel (high neck T-shirt, etc.), a sticker (patch) attached to a skin, a choker, a ribbon, a necklace, etc. Alternatively, the vibration input device may detect vibration indirectly.

The speech signal may be generated by a speech signal processing section that processes a speech input to a speech input device to which the utterance speech uttered by the user is input and generates a speech signal.

The speech signal processing section may be separate from the information processing apparatus or may be included in the information processing apparatus.

An information processing method according to an embodiment of the present disclosure
generates a first speech extraction signal by extracting an utterance speech component from a speech signal including an utterance speech uttered by a user,
generates a correction signal from a vibration signal indicating vibration of a part of the user that vibrates in conjunction with a user's utterance, and
generates an utterance speech signal indicating the utterance speech by post-processing the first speech extraction signal based on the correction signal.

An information processing program according to an embodiment of the present disclosure allows to operate an information processing apparatus as
a first speech extraction processing section that generates a first speech extraction signal by extracting an utterance speech component from a speech signal including an utterance speech uttered by a user,
a correction signal generation section that generates a correction signal from a vibration signal indicating vibration of a part of the user that vibrates in conjunction with a user's utterance, and
a post-processing section that generates an utterance speech signal indicating the utterance speech by post-processing the first speech extraction signal based on the correction signal.

An information processing system according to an embodiment of the present disclosure includes
a speech input device that inputs an utterance speech uttered by a user,
a vibration input device that inputs vibration of a part of the user that vibrates in conjunction with a user's utterance,
   and
an information processing apparatus, including
   a first speech extraction processing section that generates a first speech extraction signal by extracting an utterance speech component from a speech signal including the utterance speech,
   a correction signal generation section that generates a correction signal from a vibration signal indicating the vibration of the part, and
   a post-processing section that generates an utterance speech signal indicating the utterance speech by post-processing the first speech extraction signal based on the correction signal.

### BRIEF DESCRIPTION OF DRAWINGS

FIG. 1 shows a configuration of an information processing system according to an embodiment of the present disclosure.

FIG. 2 shows an example of a neckband type device.

FIG. 3 shows a wearing status of the neckband type device.

FIG. 4 shows an operation flow of the information processing system.

FIG. 5 shows respective signal waveforms.

### MODE(S) FOR CARRYING OUT THE INVENTION

Hereinafter, embodiments of the present disclosure will be described with reference to the drawings.

### 1. Configuration of Information Processing System

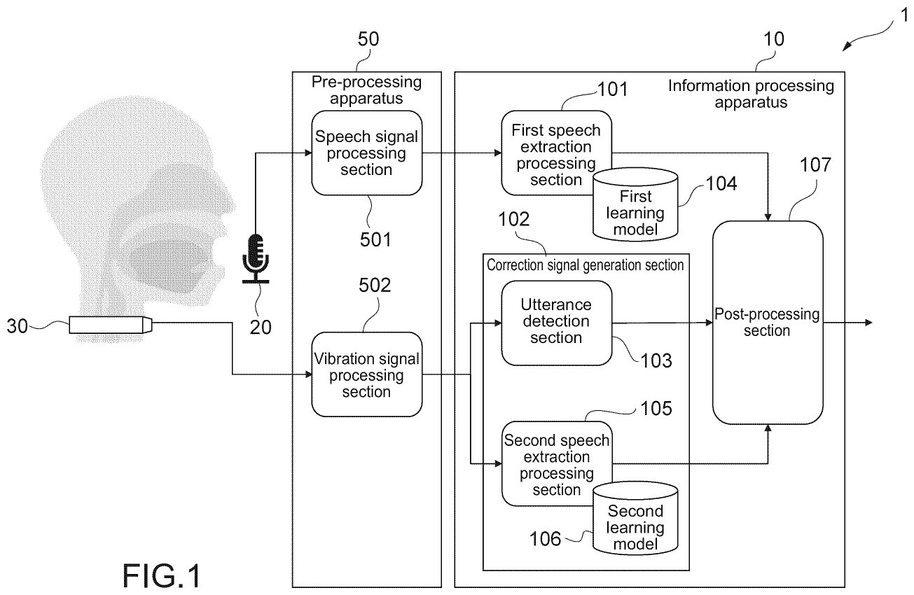

FIG. 1 shows a configuration of an information processing system according to an embodiment of the present disclosure.

An information processing system 1 extracts only an utterance speech uttered by one specific user toward a microphone by eliminating a noise including a background sound and an utterance speech of another user. An example of a use case of the information processing system 1 includes that, in an online meeting, only the utterance speech of the user is extracted and output to a speaker device of an online meeting partner. Another example of the use case includes that, in a recording device such as an IC recorder, only the utterance speech of the user is extracted and recorded. Still other example of the use case includes an utterance aid device (hearing aid device) that only an utterance speech of a user who has difficulty uttering clearly (e.g., handicapped user, elderly person, etc.) is extracted and output in a clear artificial speech. The utterance aid device may be an integrated device with a sound collector (hearing aid device).

The information processing system 1 has a pre-processing apparatus 50, an information processing apparatus 10, a speech input device 20, and a vibration input device 30.

The speech input device 20 inputs the utterance speech uttered by the user. The speech input device 20 includes a microphone. The speech input device 20 may be built into a device worn on a human body, for example, such as a neckband type device (neckband type headset, neckband type utterance aid device, etc.). The speech input device 20 may be a microphone built into a smartphone, a tablet computer, a personal computer, a head-mounted display, a wearable device, etc., or a microphone connected to these devices wired or wirelessly.

The vibration input device 30 inputs vibration of a part of the user that vibrates in conjunction with a user's utterance. The part of the user that vibrates in conjunction with the user's utterance is, for example, a part of the human body located in or around a larynx (e.g., organ), an artificial organ (such as artificial vocal cords), or a medical device. Typically, the part of the user is the vocal cords. The vibration input device 30 is a sensor (e.g., vibration sensor, acceleration sensor, angular rate sensor, etc.) that directly detects the vibration of the part and is built into a device worn on the human body. The device worn on the human body can be, for example, the neckband type device (neckband type headset, neckband type utterance aid device, etc.), apparel (high neck T-shirt, etc.), a sticker (patch) attached to a skin, a choker, a ribbon, a necklace, etc. Alternatively, the vibration input device 30 may detect the vibration indirectly, e.g., by irradiating the part with a laser to detect the vibration of the part.

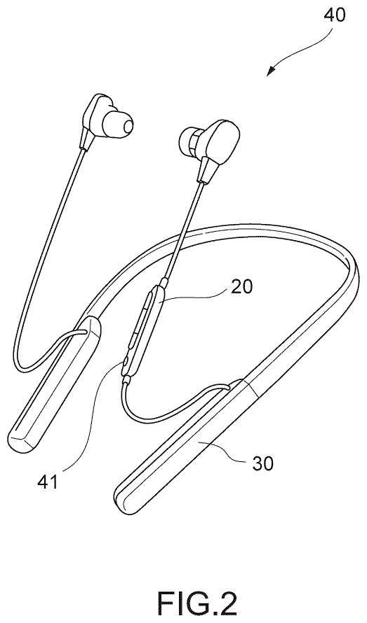

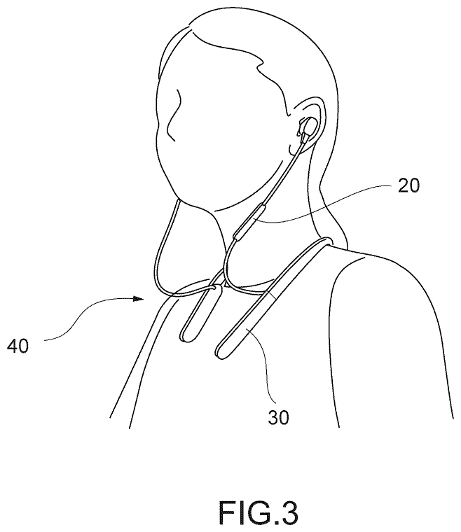

FIG. 2 shows an example of the neckband type device. FIG. 3 shows a wearing status of the neckband type device.

As an example, the speech input device 20 and the vibration input device 30 may be built into a neckband type device 40. In this case, the speech input device 20 and the vibration input device 30 may be wired (FIG. 2) or wirelessly connected. In this figure, the vibration input device 30 directly or indirectly detects the vibration of the vocal cords located in the larynx or the part of the human body (skin, muscles, bones, etc.) near the larynx as the part of the user that vibrates in conjunction with the user's utterance.

The neckband type device 40 may have a UI such as a button 41 to turn On or Off a function according to the present embodiment (described later). Turning Off the function means a mode in which the speech input to the speech input device 20 is unprocessed and output. Using the smartphone or the personal computer (not shown) connected to the neckband type device 40, confirmation of turning On/Off the function or an On/Off status may be possible.

The pre-processing apparatus 50 is realized by, for example, the smartphone, the tablet computer, the personal computer, the head-mounted display, the wearable device, etc. When the speech input device 20 and the vibration input device 30 are built into the neckband type device 40, the pre-processing apparatus 50 may be built into the neckband type device 40.

The pre-processing apparatus 50 includes a speech signal processing section 501 and a vibration signal processing section 502. The speech signal processing section 501 processes the utterance speech input to the speech input device 20 and generates the speech signal. The vibration signal processing section 502 processes the vibration input to the vibration input device 30 and generates the vibration signal. The pre-processing apparatus 50 synchronizes and supplies the speech signal and the vibration signal to the information processing apparatus 10. Typically, the pre-processing apparatus 50 supplies the speech signal and the vibration signal to the information processing apparatus 10 via a network. The pre-processing apparatus 50 may be included in the information processing apparatus 10 instead of being separate from the information processing apparatus 10.

The information processing apparatus 10 is typically a server apparatus connected to the pre-processing apparatus 50 via the network. The information processing apparatus 10 operates as a first speech extraction processing section 101, a correction signal generation section 102, and a post-processing section 107 by having the CPU load and execute an information processing program recorded in a ROM into a RAM. The correction signal generation section 102 includes a second speech extraction processing section 105 and an utterance detection section 103.

### 2. Operation Flow of Information Processing System

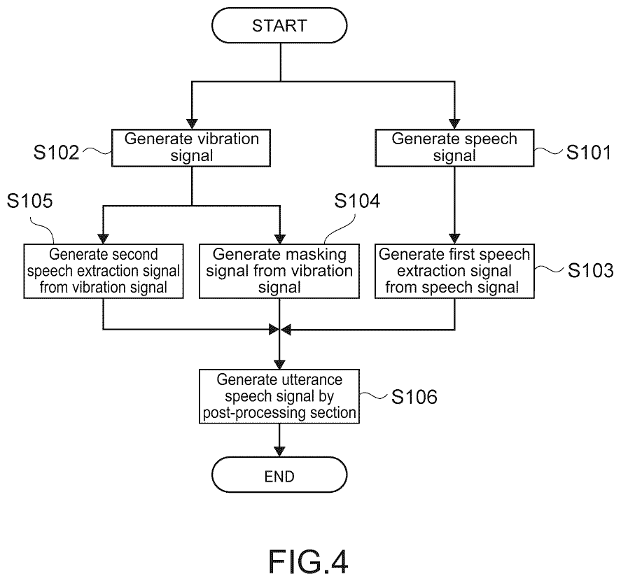

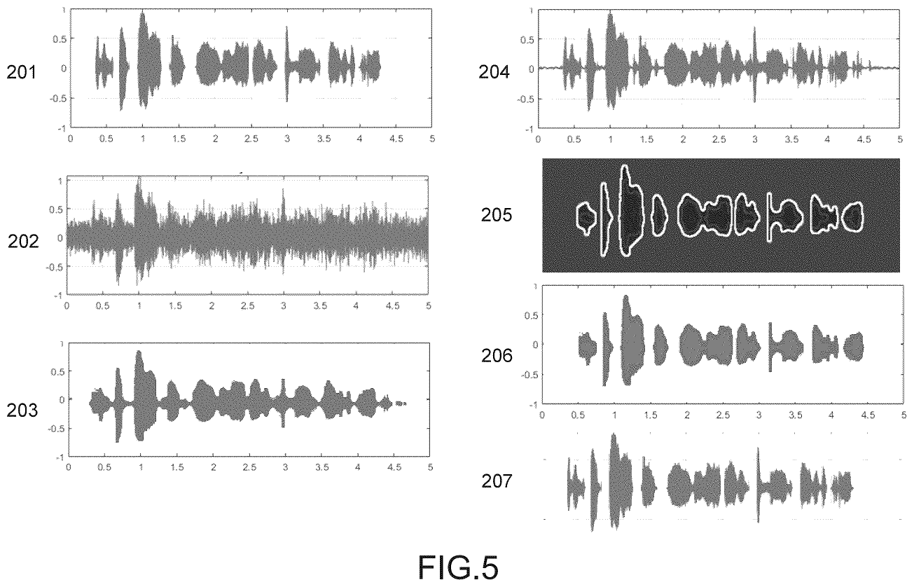

FIG. 4 shows an operation flow of the information processing system. FIG. 5 shows respective signal waveforms.

The user utters toward the speech input device 20. The speech signal processing section 501 processes (high-pass filter, low-pass filter, etc.) the speech input to the speech input device 20, which inputs the utterance speech uttered by the user, and generates a speech signal 202 (Step S101). The speech signal 202 includes the noise including the background sound and the utterance speech of another user in addition to an utterance speech waveform 201, which represents only the utterance speech of the target user. In FIG. 5, the horizontal axis indicates a time and the vertical axis indicates intensity.

The vibration signal processing section 502 processes (high-pass filter, low-pass filter, etc.) the vibration input to the vibration input device 30 of the part (vocal cords, etc.) of the user that vibrates in conjunction with the user's utterance, and generates a vibration signal 203 (Step S102).

The first speech extraction processing section 101 generates a first speech extraction signal 204 by extracting an utterance speech component from the speech signal 202 including the utterance speech uttered by the user (Step S103). Specifically, the first speech extraction processing section 101 generates the first speech extraction signal 204 by inputting the speech signal 202 to a first learning model 104. The first learning model is a machine learning model learned to output a speech extraction signal (equivalent to first speech extraction signal) using a large number of speech signals as training data.

In the correction signal generation section 102, the utterance detection section 103 generates a masking signal 205 (example of correction signal) from the vibration signal 203 (Step S104). The masking signal 205 indicates the presence or absence and intensity of the utterance speech. In the masking signal 205 of FIG. 5, the time of a continuous blank space in the horizontal axis direction means that there is no speech sound. The utterance detection section 103 generates envelope information as the masking signal 205. The vibration signal 203 does not merely indicate presence or absence of vibration (i.e., presence or absence of utterance) and depends on the utterance speech uttered by the target user, which enables generation of the highly accurate masking signal 205.

In the correction signal generation section 102, the second speech extraction processing section 105 generates a second speech extraction signal 206 (example of correction signal) by extracting the utterance speech component from the vibration signal 203 (Step S105). Specifically, the second speech extraction processing section 105 generates the second speech extraction signal 206 by inputting the vibration signal 203 to a second learning model 106. The second learning model 106 is a machine learning model learned to output the speech extraction signal (equivalent to second speech extraction signal) by using both a large number of speech signals and vibration signals as training data. The vibration signal 203 does not merely indicate presence or absence of vibration (i.e., presence or absence of utterance) and depends on the utterance speech uttered by the target user, which enables generation of the highly accurate utterance second speech extraction signal 206.

The post-processing section 107 generates the utterance speech signal 207 by post-processing the first speech extraction signal 204 based on the second speech extraction signal 206 and the masking signal 205. The generated utterance speech signal 207 is transmitted to and replayed on the information processing apparatus 10 used by other participants of the online meeting. One example of the post-processing is feature association processing. For example, the post-processing section 107 may associate the first speech extraction signal 204 with the second speech extraction signal 206, mask it with the masking signal 205, and generate the result as the utterance speech signal 207. The utterance speech signal 207 desirably matches the speech sound waveform 201 indicating only the utterance speech uttered by the target user. The vibration signal 203, which is the basis of the second speech extraction signal 206 and the masking signal 205, does not merely indicate presence or absence of vibration (presence or absence of utterance) and depends on the utterance speech uttered by the target user, which enables generation of the highly accurate utterance speech signal 207. The post-processing section 107 outputs the utterance speech signal 207 (Step S106). Conversely, the post-processing section 107 may output a removal signal (background sound, etc.) generated by removing the utterance speech signal 207 from the speech signal 202.

As a modification embodiment, the correction signal generation section 102 may have at least one of the second speech extraction processing section 105 or the utterance detection section 103. In this case, the post-processing section 107 may generate the second speech signal 207 by post-processing the first speech extraction signal 204 based on at least one of the second speech extraction signal 206 or the masking signal 205. If the second speech extraction processing section 105 or the utterance detection section 103 is unable to generate the second speech extraction signal 206 or the masking signal 205 for some reason, the post-processing section 107 may generate the second speech signal 207 by post-processing the first speech extraction signal 204 based on at least one of the second speech extraction signal 206 or the masking signal 205. Even in this way, since the first speech extraction signal is post-processed based on at least one of the second speech extraction signal 206 or the masking signal 205, accuracy of the utterance speech signal 207 is improved compared to the case in which the first speech extraction signal 204 is assumed to be the final output.

### 3. Conclusion

Typically, a machine-learning type speech extraction technology aims to extract only a human speech from a signal including a noise by learning a wide variety of speech samples without using a reference signal. On the other hand, when a microphone input signal includes speeches from multiple people, it is difficult to extract only the speech signal of a specific speaker from among them.

In contrast, according to the present embodiment, only a user's speech can be accurately extracted and transmitted or recorded, even in the presence of the noise including the background sound and the utterance speech of another user. The accuracy can also be improved for whispered voices, making it possible to conduct online meetings or other types of meetings regardless of the location.

The present disclosure may also have the following structures.
(1) An information processing apparatus, including:
   a first speech extraction processing section that generates a first speech extraction signal by extracting an utterance speech component from a speech signal including an utterance speech uttered by a user;
   a correction signal generation section that generates a correction signal from a vibration signal indicating vibration of a part of the user that vibrates in conjunction with a user's utterance; and
   a post-processing section that generates an utterance speech signal indicating the utterance speech by post-processing the first speech extraction signal based on the correction signal.
(2) The information processing apparatus according to (1), in which
   the correction signal generation section includes a second speech extraction processing section that generates a second speech extraction signal by extracting the utterance speech component from the vibration signal, and
   the post-processing section generates the utterance speech signal by post-processing the first speech extraction signal based on the second speech extraction signal.
(3) The information processing apparatus according to (1), in which
   the correction signal generation section includes an utterance detection section that generates a masking signal indicating presence or absence and intensity of the utterance speech from the vibration signal, and
   the post-processing section generates the utterance speech signal by post-processing the first speech extraction signal based on the masking signal.
(4) The information processing apparatus according to (1), in which
   the correction signal generation section includes
      a second speech extraction processing section that generates a second speech extraction signal by extracting the utterance speech component from the vibration signal, and
      an utterance detection section that generates a masking signal indicating presence or absence and intensity of the utterance speech from the vibration signal, and
   the post-processing section generates the utterance speech signal by post-processing the first speech extraction signal based on the second speech extraction signal and the masking signal.
(5) The information processing apparatus according to any one of (1) to (4), in which
   the first speech extraction processing section generates the first speech extraction signal by inputting the speech signal to a first learning model learned to output a first speech extraction signal using the speech signal as training data.
(6) The information processing apparatus according to (2) or (4), in which
   the second speech extraction processing section generates the second speech extraction signal by inputting the vibration signal to a second learning model learned to output a second speech extraction signal using the speech signal and the vibration signal as the training data.
(7) The information processing apparatus according to (3) or (4), in which
   the utterance detection section generates envelope information as the masking signal.
(8) The information processing apparatus according to any one of (1) to (7), in which
   the part of the user that vibrates in conjunction with the user's utterance is a part of a human body located in or around a larynx, an artificial organ, or a medical device.
(9) The information processing apparatus according to any one of (1) to (8), in which
   the post-processing section
      outputs the utterance speech signal, or
      outputs a removal signal generated by removing the utterance speech signal from the speech signal.
(10) The information processing apparatus according to any one of (1) to (9), in which
   the vibration signal is generated by a vibration signal processing section that processes vibration input to a vibration input device to which the vibration of the part is input and generates the vibration signal.
(11) The information processing apparatus according to (10), in which
   the vibration input device
      is a sensor that directly detects the vibration of the part, and is built into a device worn on the human body, or
      detects the vibration of the part by irradiating the part with a laser.
(12) The information processing apparatus according to any one of (1) to (11), in which
   the speech signal is generated by a speech signal processing section that processes a speech input to a speech input device to which the utterance speech uttered by the user is input and generates the speech signal.
(13) An information processing method, including:
   generating a first speech extraction signal by extracting an utterance speech component from a speech signal including an utterance speech uttered by a user;
   generating a correction signal from a vibration signal indicating vibration of a part of the user that vibrates in conjunction with a user's utterance, and
   generating an utterance speech signal indicating the utterance speech by post-processing the first speech extraction signal based on the correction signal.
(14) An information processing program that allows an information processing apparatus to operate as:
   a first speech extraction processing section that generates a first speech extraction signal by extracting an utterance speech component from a speech signal including an utterance speech uttered by a user,
   a correction signal generation section that generates a correction signal from a vibration signal indicating vibration of a part of the user that vibrates in conjunction with a user's utterance, and
   a post-processing section that generates an utterance speech signal indicating the utterance speech by post-processing the first speech extraction signal based on the correction signal.
(15) An information processing system, including:
   a speech input device that inputs an utterance speech uttered by a user,
   a vibration input device that inputs vibration of a part of the user that vibrates in conjunction with a user's utterance, and
   an information processing apparatus, including
      a first speech extraction processing section that generates a first speech extraction signal by extracting an utterance speech component from a speech signal including the utterance speech,
      a correction signal generation section that generates a correction signal from a vibration signal indicating the vibration of the part, and
      a post-processing section that generates an utterance speech signal indicating the utterance speech by post-processing the first speech extraction signal based on the correction signal.
(16) A non-transitory computer-readable storage medium recording an information processing program that allows an information processing apparatus to operate as:
   a first speech extraction processing section that generates a first speech extraction signal by extracting an utterance speech component from a speech signal including an utterance speech uttered by a user,
   a correction signal generation section that generates a correction signal from a vibration signal indicating vibration of a part of the user that vibrates in conjunction with a user's utterance, and
   a post-processing section that generates an utterance speech signal indicating the utterance speech by post-processing the first speech extraction signal based on the correction signal.

Although each embodiment and each modification embodiment of the present technology has been described above, it should be appreciated that the present technology is not limited only to the embodiments described above, and various changes can be made without departing from the scope of the gist of the present technology.

### REFERENCE SIGNS LIST

1 information processing system
10 information processing apparatus
101 first speech extraction processing section
102 correction signal generation section
103 utterance detection section
104 first learning model
105 second speech extraction processing section
106 second learning model
107 post-processing section
20 speech input device
201 utterance speech waveform
202 speech signal
203 vibration signal
204 first speech extraction signal
205 masking signal
206 second speech extraction signal
207 utterance speech signal
30 vibration input device
40 neckband type device
41 button
50 pre-processing apparatus
501 speech signal processing section
502 vibration signal processing section

1. An information processing apparatus, comprising:
a first speech extraction processing section that generates a first speech extraction signal by extracting an utterance speech component from a speech signal including an utterance speech uttered by a user;
a correction signal generation section that generates a correction signal from a vibration signal indicating vibration of a part of the user that vibrates in conjunction with a user's utterance; and
a post-processing section that generates an utterance speech signal indicating the utterance speech by post-processing the first speech extraction signal based on the correction signal.

2. The information processing apparatus according to claim 1, wherein
the correction signal generation section includes a second speech extraction processing section that generates a second speech extraction signal by extracting the utterance speech component from the vibration signal, and
the post-processing section generates the utterance speech signal by post-processing the first speech extraction signal based on the second speech extraction signal.

3. The information processing apparatus according to claim 1, wherein
the correction signal generation section includes an utterance detection section that generates a masking signal indicating presence or absence and intensity of the utterance speech from the vibration signal, and
the post-processing section generates the utterance speech signal by post-processing the first speech extraction signal based on the masking signal.

4. The information processing apparatus according to claim 1, wherein
the correction signal generation section includes
a second speech extraction processing section that generates a second speech extraction signal by extracting the utterance speech component from the vibration signal, and
an utterance detection section that generates a masking signal indicating presence or absence and intensity of the utterance speech from the vibration signal, and
the post-processing section generates the utterance speech signal by post-processing the first speech extraction signal based on the second speech extraction signal and the masking signal.

5. The information processing apparatus according to claim 1, wherein
the first speech extraction processing section generates the first speech extraction signal by inputting the speech signal to a first learning model learned to output a first speech extraction signal using the speech signal as training data.

6. The information processing apparatus according to claim 2, wherein
the second speech extraction processing section generates the second speech extraction signal by inputting the vibration signal to a second learning model learned to output a second speech extraction signal using the speech signal and the vibration signal as the training data.

7. The information processing apparatus according to claim 3, wherein
the utterance detection section generates envelope information as the masking signal.

8. The information processing apparatus according to claim 1, wherein
the part of the user that vibrates in conjunction with the user's utterance is a part of a human body located in or around a larynx, an artificial organ, or a medical device.

9. The information processing apparatus according to claim 1, wherein
the post-processing section
outputs the utterance speech signal, or
outputs a removal signal generated by removing the utterance speech signal from the speech signal.

10. The information processing apparatus according to claim 1, wherein
the vibration signal is generated by a vibration signal processing section that processes vibration input to a vibration input device to which the vibration of the part is input and generates the vibration signal.

11. The information processing apparatus according to claim 10, wherein
the vibration input device
is a sensor that directly detects the vibration of the part, and is built into a device worn on the human body, or
detects the vibration of the part by irradiating the part with a laser.

12. The information processing apparatus according to claim 1, wherein
the speech signal is generated by a speech signal processing section that processes a speech input to a speech input device to which the utterance speech uttered by the user is input and generates the speech signal.

13. An information processing method, comprising:
generating a first speech extraction signal by extracting an utterance speech component from a speech signal including an utterance speech uttered by a user;
generating a correction signal from a vibration signal indicating vibration of a part of the user that vibrates in conjunction with a user's utterance; and
generating an utterance speech signal indicating the utterance speech by post-processing the first speech extraction signal based on the correction signal.

14. An information processing program that allows an information processing apparatus to operate as:
a first speech extraction processing section that generates a first speech extraction signal by extracting an utterance speech component from a speech signal including an utterance speech uttered by a user;
a correction signal generation section that generates a correction signal from a vibration signal indicating vibration of a part of the user that vibrates in conjunction with a user's utterance; and
a post-processing section that generates an utterance speech signal indicating the utterance speech by post-processing the first speech extraction signal based on the correction signal.

15. An information processing system, comprising:
a speech input device that inputs an utterance speech uttered by a user;
a vibration input device that inputs vibration of a part of the user that vibrates in conjunction with a user's utterance; and
an information processing apparatus, including
a first speech extraction processing section that generates a first speech extraction signal by extracting an utterance speech component from a speech signal including the utterance speech,
a correction signal generation section that generates a correction signal from a vibration signal indicating the vibration of the part, and
a post-processing section that generates an utterance speech signal indicating the utterance speech by post-processing the first speech extraction signal based on the correction signal.
